(19) United States
(12) Patent Application Publication
(10) Pub. No.: US 2024/0031264 A1
(43) Pub. Date: Jan. 25, 2024

(54) MONITORING PERFORMANCE OF APPLICATIONS WITH RESPECT TO SOFTWARE DEFINED WIDE AREA NETWORK EDGE DEVICES

(71) Applicant: VMWARE, INC., Palo Alto, CA (US)

(72) Inventors: Avinash Nigam, Lucknow (IN); Prashant JAIN, Jaipur (IN); Upasana Prasad PISE, Pune (IN); Shriya TALWAR, Ghaziabad (IN); Sameer P. KARVE, Pune (IN); Aditya KINTALI, Pune (IN)

(21) Appl. No.: 17/968,838

(22) Filed: Oct. 19, 2022

(30) Foreign Application Priority Data
Jul. 22, 2022 (IN) 202241042205

(51) Int. Cl. H04L 43/0823; H04L 41/0604

(52) U.S. Cl. CPC H04L 43/0823; H04L 41/0604

(57) ABSTRACT

Systems and methods for more effectively monitoring the performance of applications with respect to their associated SD-WAN edge devices. Variables are formulated for measuring the performance of individual applications accessed from an individual edge device. In some embodiments of the disclosure, flow records such as Internet Protocol Flow Information Export (IPFIX) records are collected. Records specific to a particular application and a particular edge device from which the application is accessed may be extracted and assembled into a variable which illustrates the performance of that application from that edge device over time.

### RELATED APPLICATIONS

Benefit is claimed under 35 U.S.C. 119(a)-(d) to Foreign Application Serial No. 202241042205 filed in India entitled “MONITORING PERFORMANCE OF APPLICATIONS WITH RESPECT TO SOFTWARE DEFINED WIDE AREA NETWORK EDGE DEVICES”, on Jul. 22, 2022, by VMware, Inc., which is herein incorporated in its entirety by reference for all purposes.

### FIELD

The present disclosure relates generally to software defined wide area networks (SD-WANs). More specifically, the present disclosure relates to systems and methods for monitoring performance of applications with respect to SD-WAN edge devices.

### BACKGROUND

Wide area networks (WANs) are commonly employed to provide end user access to telecommunications network hardware over large geographic distances. WANs often suffer from certain drawbacks, however, such as difficulties in integrating multiple service providers to cover these large geographic distances. Software defined WANs (SD-WANs) have found more recent acceptance as one approach to addressing these drawbacks and improving network performance. More specifically, SD-WANs virtualize applications and other services, decoupling networking hardware from management and operation of such applications/services. In this manner, SD-WAN technology provides improved branch agility, scalability, and more secure and reliable access to applications hosted in datacenters or the cloud. In an effort to increase the acceptance of SD-WANs, ongoing efforts exist to improve their performance, as well as the performance of their applications.

### SUMMARY

In some embodiments of this disclosure, systems and methods are described for more effectively monitoring the performance of application programs with respect to their associated SD-WAN edge devices. Variables are formulated for measuring the performance of individual applications accessed from an individual edge device. This allows for measurement of performance on both a per-application and a per-edge device basis. In this manner, SD-WAN connectivity issues may be measured with increased granularity, allowing for more effective determination of root causes of performance issues and more effective troubleshooting.

A computer implemented method for monitoring application performance with respect to edge devices is described, and includes: receiving data flow records for a plurality of SD-WAN edge devices each permitting access to a plurality of application programs, the data flow records comprising data flow information for each application program accessed from each SD-WAN edge device; for each application program accessed from each SD-WAN edge device, extracting the respective data flow information so as to form a data flow variable describing data flow of a particular application program accessed from a particular SD-WAN edge device; determining, from one or more of the data flow variables, whether anomalous behavior of a particular application program accessed from a particular SD-WAN edge device has occurred; and transmitting an alert to a user if the anomalous behavior has occurred.

A non-transitory computer-readable storage medium is described. The computer-readable storage medium includes instructions configured to be executed by one or more processors of a computing device and to cause the computing device to carry out steps that include: receiving data flow records for a plurality of SD-WAN edge devices each permitting access to a plurality of application programs, the data flow records comprising data flow information for each application program accessed from each SD-WAN edge device; for each application program accessed from each SD-WAN edge device, extracting the respective data flow information so as to form a data flow variable describing data flow of a particular application program accessed from a particular SD-WAN edge device; determining, from one or more of the data flow variables, whether anomalous behavior of a particular application program accessed from a particular SD-WAN edge device has occurred; and transmitting an alert to a user if the anomalous behavior has occurred.

Other aspects and advantages of embodiments of the disclosure will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 is a diagram illustrating an exemplary server cluster suitable for use with embodiments of the disclosure described herein;

FIG. 2 is a diagram conceptually illustrating an exemplary SD-WAN configuration for use with embodiments of the disclosure described herein;

FIG. 3 is a diagram illustrating an exemplary system for monitoring performance of SD-WAN applications with respect to edge devices, for use with embodiments of the disclosure described herein;

FIG. 4 is a flow chart depicting a method for generating variables for monitoring performance of SD-WAN applications with respect to edge devices, for use with embodiments of the disclosure described herein;

FIG. 5 is a flow chart depicting a method for determining anomalous behavior of SD-WAN applications with respect to edge devices, for use with embodiments of the disclosure described herein;

FIGS. 6A-6B illustrate exemplary flow records used in generating variables for monitoring performance of SD-WAN applications with respect to edge devices, for use with embodiments of the disclosure described herein; and

FIG. 7 is a graph of an exemplary variable monitoring performance of an SD-WAN application with respect to an edge device, illustrating exemplary aspects of embodiments of the disclosure described herein.

### DETAILED DESCRIPTION

Certain details are set forth below to provide a sufficient understanding of various embodiments of the disclosure. However, it will be clear to one skilled in the art that embodiments of the disclosure may be practiced without one or more of these particular details, or with other details. Moreover, the particular embodiments of the present disclosure described herein are provided by way of example and should not be used to limit the scope of the disclosure to these particular embodiments. In other instances, hardware components, network architectures, and/or software operations have not been shown in detail in order to avoid unnecessarily obscuring the disclosure.

In some embodiments of this disclosure, systems and methods are described for more effectively measuring the performance of SD-WAN applications and their associated edge devices. Variables are formulated for measuring the performance of individual applications accessed from an individual edge device. In some embodiments of the disclosure, flow records such as Internet Protocol Flow Information Export (IPFIX) records are collected. Records specific to a particular application and a particular edge device from which the application is accessed may be extracted and assembled into a variable which illustrates the performance of that application from that edge device over time.

In this manner, variables may be assembled which allow for measurement of performance on both a per-application and a per-edge device basis. Accordingly, SD-WAN connectivity issues may be measured with increased granularity, allowing for more effective determination of root causes of performance issues and more effective troubleshooting.

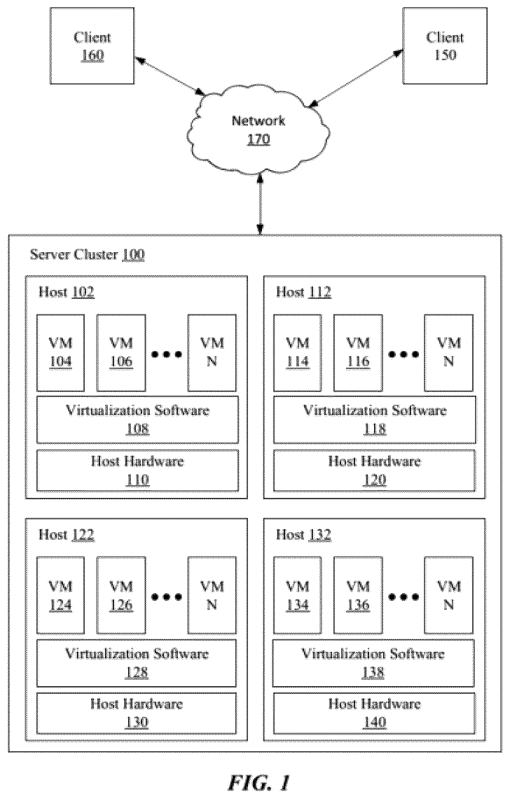

FIG. 1 shows a block diagram illustrating an exemplary server cluster 100 suitable for use with embodiments of the disclosure. Server cluster 100 can include hosts 102, 112, 122 and 132. While a four host system is shown for exemplary purposes, it should be appreciated that server cluster 100 could include a larger or smaller number of hosts. Each host 102-132 includes host hardware 110-140, which can include a designated amount of processing, memory, network and/or storage resources. In some embodiments, each of the hosts provide the same amount of resources, and in other embodiments, the hosts are configured to provide different amounts of resources to support one or more virtual machines (VMs) running on the hosts. Each of the VMs can be configured to run a guest operating system that allows for multiple applications or services to run within the VM.

Each of hosts 102, 112, 122 and 132 are capable of running virtualization software 108, 118, 128 and 138, respectively. The virtualization software can run within a virtual machine (VM) and includes management tools for starting, stopping and managing various virtual machines running on the host. For example, host 102 can be configured to stop or suspend operations of virtual machines 104 or 106 utilizing virtualization software 108. Virtualization software 108, commonly referred to as a hypervisor, can also be configured to start new virtual machines or change the amount of processing or memory resources from host hardware 110 that are assigned to one or more VMs running on host 102. Host hardware 110 includes one or more processors, memory, storage resources, I/O ports and the like that are configured to support operation of VMs running on host 102. In some embodiments, a greater amount of processing, memory or storage resources of host hardware 110 is allocated to operation of VM 104 than to VM 106. This may be desirable when, e.g., VM 104 is running a larger number of services or running on a more resource intensive operating system than VM 106. Clients 150 and 160 are positioned outside server cluster 100 and can request access to services running on server cluster 100 via network 170. Responding to the request for access and interacting with clients 150 and 160 can involve interaction with a single service or in other cases may involve multiple smaller services cooperatively interacting to provide information requested by clients 150 and/or 160.

Hosts 102, 112, 122 and 132, which make up server cluster 100, can also include or have access to a storage area network (SAN) that can be shared by multiple hosts. The SAN is configured to provide storage resources as known in the art. In some embodiments, the SAN can be used to store log data or flow records generated during operation of server cluster 100. While description is made herein with respect to the operation of individual ones of hosts 110-140, it will be appreciated that other hosts 110-140 provide analogous functionality, respectively. Log data and flow records may also be stored in one or more host 102, 112, 122 and 132 memories.

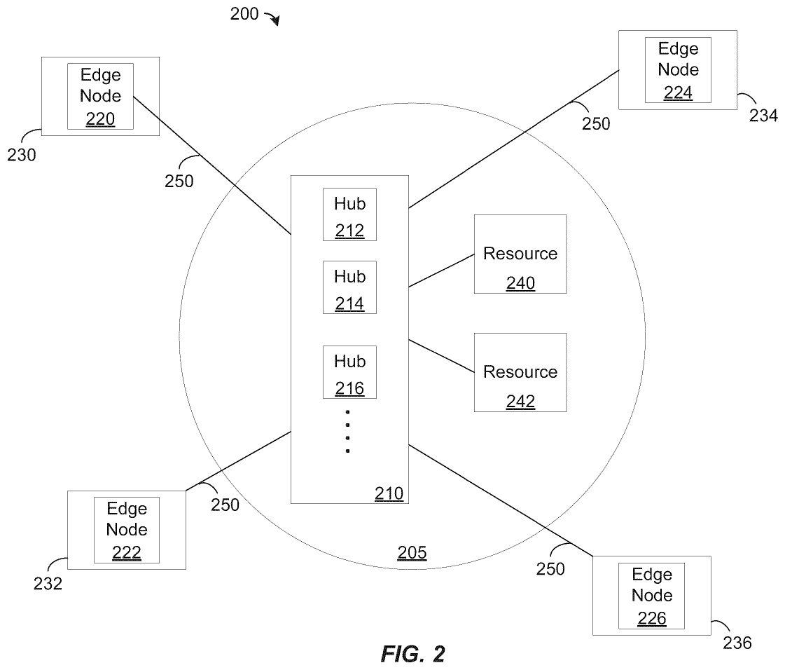

FIG. 2 is a diagram conceptually illustrating an exemplary SD-WAN configuration for use with embodiments of the disclosure described herein.

In some embodiments, the illustrated SD-WAN network, which may also be referred to as a virtual network, can connect multiple branch sites to each other and to resources of a centralized datacenter. In this example, the SD-WAN 200 is created for connecting the branch sites 230-236 to each other and to resources 240, 242 of the datacenter 205, via the sets of hubs 212-216 (of which there may be any number, and which may also be referred to herein as forwarding hub nodes) of the hub cluster 210. The SD-WAN 200 is established by a controller cluster (not shown), the sets of hubs 212-216, and four exemplary edge nodes 220-226, one in each of the branch sites 230-236.

The edge nodes 220-226 in some embodiments are edge devices such as edge machines (e.g., VMs 104, 106, etc., containers, programs executing on computers, etc.) and/or standalone appliances that operate at multi-computer locations of the particular entity (e.g., at an office or datacenter of the entity) to connect the computers at their respective locations to the hubs 212-216 and other edge nodes (if so configured). Thus, for example, each branch site 230-236 may have a server cluster 100 that contains or generates its respective edge node 220-226 as, e.g., one or more VMs 104, 106, etc. In some embodiments, the edge nodes 220-226 are clusters of edge nodes at each of the branch sites 230-236. In other embodiments, the edge nodes 220-226 are deployed to each of the branch sites 230-236 as high-availability pairs such that one edge node in the pair is the active edge node and the other edge node in the pair is the standby edge node that can take over as the active edge node in case of failover. Also, in this example, the sets of hubs 212-216 are deployed as machines (e.g., VMs 204 and 206 or containers) in the same public datacenter 205. In other embodiments, the hubs may be deployed in different public datacenters.

In some embodiments of the disclosure, the hubs 212-216 are multi-tenant forwarding elements that can be used to establish secure connection links (e.g., tunnels) with edge nodes 220-226 at SD-WAN network 200 multi-computer sites, such as branch sites (branch offices), datacenters (e.g., third party datacenters), or the like. For example, the sets of hubs 212-216 in the cluster 210 provide access from each of the branch sites 230-236 to each of the other branch sites 230-236, as well as to other remote datacenters (not shown), via the connection links 250, which terminate at the cluster 210 as shown. These multi-computer sites are often at different physical locations (e.g., different buildings, different cities, different states, etc.), according to some embodiments. In some embodiments, the forwarding hub nodes 212-216 can be deployed as physical nodes or virtual nodes. Additionally, the forwarding hub nodes 212-216 can be deployed on a datacenter premises in some embodiments, while in other embodiments, the forwarding hub nodes 212-216 can be deployed on a cloud (e.g., as a set of virtual edges configured as a cluster). Thus, in some embodiments, datacenter 205 may house a server cluster 100 that contains or generates hub cluster 210, and its respective hubs 212-216, e.g., as one or more VMs 104, 106, etc.

In the example of FIG. 2, the sets of hubs 212-216 also provide access to resources 240-242 (e.g., machines) of the datacenter 205. The resources 240-242 in some embodiments include a set of one or more servers (e.g., web servers, database servers) within a microservices container (e.g., a pod). Conjunctively, or alternatively, some embodiments include any number of such microservices containers, each accessible through a different set of one or more hubs 212-216 of the datacenter. In some embodiments, the resources 240-242, as well as the hubs 212-216, are within the datacenter 205 premises.

The edge nodes 220-226 are forwarding elements that exchange packets with one or more hubs 212-216 and/or other edge nodes 220-226 through one or more secure connection links 250, according to some embodiments. In this example, all secure connection links 250 of the edge nodes 220-226 are with the sets of hubs 212-216. FIG. 2 also illustrates that through the set of hubs 212-216, the SD-WAN 200 allows the edge nodes 220-226 to connect to any number of various other datacenters. While not shown, some embodiments include multiple different other datacenters, which may each be accessible via different sets of hubs, according to some embodiments. In some embodiments, these other datacenters may provide access to storage, and/or to any application programs or services. As shown, the branch sites 230-236 and any remote datacenters are topologically arranged around the datacenter 205 in a hub and spoke topology. Thus, in some embodiments, traffic between any two sites must pass through the sets of hubs 212-216 at the datacenter 205 regardless of the geographic location of the sites 230-236.

The sets of hubs 212-216 in some embodiments provide the branch sites 230-236 with access to compute, storage, and service resources of the datacenter 205 such as the resources 240-242, as well as those of other datacenters. Examples of such resources 240-242 include compute machines (e.g., virtual machines and/or containers providing server operations), storage machines (e.g., database servers), and middlebox service operations (e.g., firewall services, load balancing services, encryption services, etc.). In some embodiments, the connections 250 between the branch sites 230-236 and the datacenter hubs 212-216 are secure encrypted connections that encrypt packets exchanged between the edge nodes 220-226 of the branch sites 230-236 and the hubs 212-216. Examples of secure encrypted connections used in some embodiments include VPN (virtual private network) connections, or secure IPsec (Internet Protocol security) connections. It is also noted that in some embodiments, connections 250 may be any pathways suitable for data exchange between any network elements, secured or otherwise.

In some embodiments, multiple secure connection links (e.g., multiple secure tunnels) can be established between an edge node 220-226 and a hub 212-216. When multiple such links are defined between an edge node 220-226 and a hub 212-216, each secure connection link, in some embodiments, is associated with a different physical network link between the edge node 220-226 and an external network. For instance, to access external networks in some embodiments, an edge node 220-226 has one or more commercial broadband Internet links (e.g., a cable mode and a fiber optic link) to access the Internet, a wireless cellular link (e.g., a 5G LTE network), etc.

In some embodiments, each secure connection link between a hub 212-216 and an edge node 220-226 is formed as a VPN tunnel between the respective hub 212-216 and edge node 220-226. As described above, the set of hubs 212-216 also connects the edge nodes 220-226 to other remote datacenters. In some embodiments, these connections are through secure VPN tunnels. The collection of the edge nodes 220-226, hubs 212-216, and secure connections between the edge nodes 220-226, hubs 212-216, and other remote datacenters forms the SD-WAN 200, through which users may access desired resources such as applications or services.

In some embodiments of the disclosure, edge nodes 220-226 forward packets to hubs 212-216 based on hub-selection rules that each identify a set of one or more hubs (e.g., the sets of hubs 212-216) of the datacenter 205 for receiving one or more flows from the branch sites 230-236. In some embodiments, the edge nodes 220-226 use flow attributes of received packets to identify hub-selection rules. The edge nodes 220-226 identify hub-selection rules for received packets by matching flow attributes of the received packets with the match criteria of the hub-selection, which associate the match criteria with one or more identifiers of one or more forwarding hub nodes of the datacenter 205, according to some embodiments. In this manner, hubs 212-216 determine the appropriate destinations of received packets and forward them to the specified destination, e.g., resources 240-242, a remote datacenter, or any other specified destination.

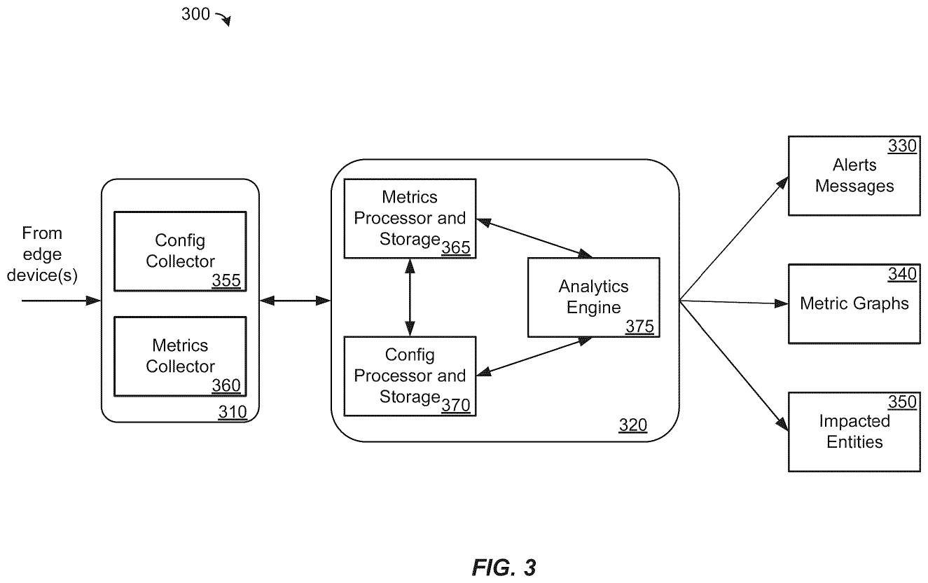

FIG. 3 is a diagram illustrating an exemplary system for monitoring performance of SD-WAN applications with respect to edge devices, for use with embodiments of the disclosure described herein. Here, an internet protocol (IP) flow monitoring system 300 includes a collector 310 for reading and gathering edge device flow records, and an application monitoring platform 320 for assembling variables of embodiments of the disclosure from flow records gathered by collector 310. Platform 320 may generate various outputs from the assembled variables, including but not limited to alerts 330, graphs 340, and lists of impacted entities 350 or entities impacted by anomalous performance of various applications, as determined by the assembled variables. In some embodiments of the disclosure, collector 310 and/or platform 320 may be implemented as one or more application programs run on a hardware device such as a host (e.g., host 102, 112, 122, or 132) of a server cluster 100, or any other computing device capable of electronic communication with edge nodes 220-226. In some embodiments, one or more of collector 310 and platform 320 may alternatively be implemented as dedicated hardware devices programmed to collect flow records from one or more edge devices 220-226, calculate any variables of embodiments of the disclosure, and generate reports and/or alerts accordingly.

Collector 310 may contain a configuration collector module 355 and a metrics collector module 360, which may be implemented as programs, or dedicated hardware modules. In operation, configuration collector module 355 may read packets transmitted/received by an edge device 220-226, and compile packet flow information, or flow records, read from the packets. As one example, collector module 355 may read and compile IPFIX data from IP traffic of an edge device 220-226. Such data may be any information contained in any packet of IP traffic, including but not limited to packet source addresses, destination addresses, application identifiers, source/destination bytes, and the like. Metrics collector 360 may also analyze IP traffic to determine desired information or metrics therefrom which may be useful in characterizing the data flow of applications and/or edge devices, including for example a number of lost packets, round trip time (RTT), flow direction, and any other IP traffic statistics or information that may be desired.

Platform 320 may receive flow records from collector module 355 and metrics from metrics collector 360. From this information, platform 320 may compile any desired variables or quantities characterizing the performance of individual applications accessed via its edge device 220-226. In exemplary operation, configuration processor and storage module 370 may process the flow records from collector module 355 to extract that flow data which is specific to one particular application and the particular edge device 220-226 it is accessed through. This extracted flow data may then be transmitted to analytics engine 375. In addition, metrics processor and storage module 365 may process metrics compiled by metrics collector 360 to add to the corresponding application- and edge-specific flow data determined by configuration processor 370. In one embodiment of the disclosure, configuration processor 370 may analyze destination data and/or application IDs (extracted from IP traffic by configuration collector 355, as above) to identify those flow records for a specific application and a specific edge device 220-226 through which the application is accessed. These specific flow records may then be copied, and analytics engine 375 may append the corresponding metrics from metrics processor 365 thereto. As above, appended metrics may include such quantities as RTT and packet loss for packets traveling to/from that specific application through that specific edge device. In this manner, analytics engine 375 may generate a variable containing a continuous record of flow data specific to particular applications and the specific edge devices through which they are accessed.

Analytics engine 375 then performs any desired analysis of these variables, i.e., application- and edge device-specific flow records and associated metrics, to determine whether the performance of a particular application or edge device has been compromised or is problematic in some manner. In some embodiments, analytics engine 375 may generate and transmit alerts 330 to users or any other desired entity when the variables indicate compromised performance of an application or edge device. Analytics engine 375 may also generate graphs 340 graphically illustrating variables or components thereof over time, as well as lists 350 of entities that may be impacted by compromised performance of specific applications or edge devices. In this manner, flow monitoring system 300 may identify specific applications and edge devices of an SD-WAN environment whose performance is compromised in some manner, and alert users or other desired entities accordingly.

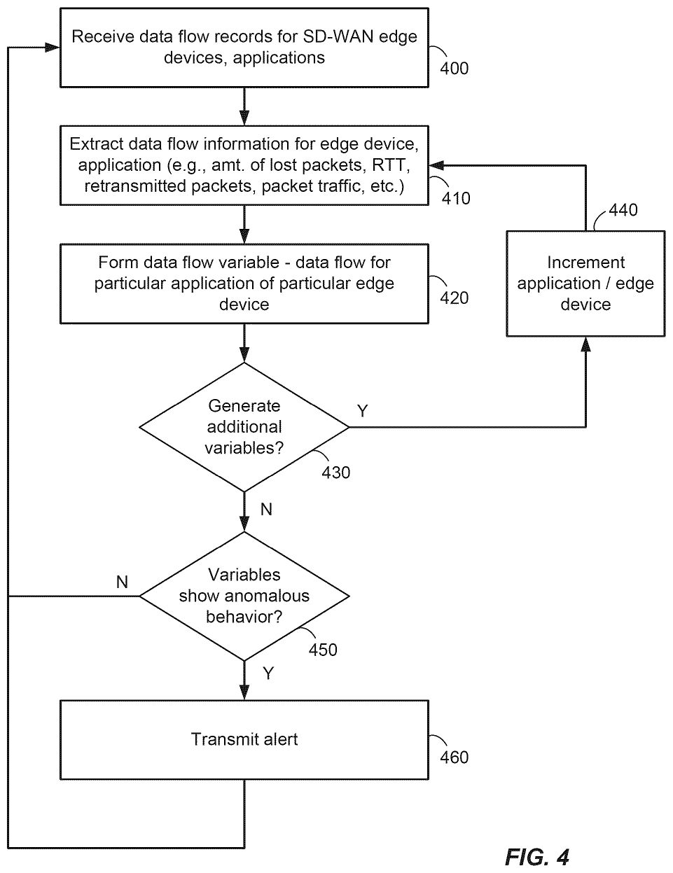

FIG. 4 is a flow chart depicting a method for generating variables for monitoring performance of SD-WAN applications with respect to edge devices, for use with embodiments of the disclosure described herein. Initially, collector 310 may receive, from a particular edge device 220-226, data flow records for each application program accessed from that edge device 220-226 (Step 400). As above, collector 310 may read packet data of IP traffic to/from a particular edge device 220-226, such as packet source addresses, destination addresses, application identifiers, source/destination bytes, and the like. The compiled data flow records may include this and other data, as above.

Platform 320 may then extract data flow information for that particular edge device 220-226 and particular application programs accessed from that edge device 220-226 (Step 410). In some embodiments, platform 320 may extract, from the stream of IP traffic packet data generated by collector 310, that packet data which is specific to a particular application accessed from that edge device 220-226. This extracted flow data may then be deemed a data flow variable characterizing data flow of one particular application as accessed from one particular edge device (Step 420). Metrics from metrics processor 365 may be appended to these variables as desired, to improve the characterization of data flow for applications and their associated edge devices 220-226.

The process of FIG. 4 may continue to Step 450 for analysis of any determined variables. Also, the process of Steps 410-420 may optionally be repeated for other applications of the edge device 220-226 (Steps 430, 440), so that a data flow variable is formed for other applications accessed from the particular edge device 220-226. That is, a set of data flow variables may be determined, each characterizing the data flow for an application accessed via an edge device 220-226. In this manner, the behavior of every application accessed through an edge device may be monitored.

Analytics engine 375 may then analyze the variables to determine whether any show anomalous behavior of an application and/or edge device (Step 450). Variables may be analyzed in any manner, using any criteria, to determine whether they have detected anomalous behavior of any application or edge device. As one example, variables may be deemed to indicate anomalous behavior, and trigger an alert, when one or more of their values deviates from a predetermined baseline or historic average value by some predetermined amount that is deemed significant. For instance, a median absolute deviation technique may be employed to capture data flow variable values over any one or more desired periods of time, and determine the median and median absolute deviation thereof. Data flow variable values that exceed the median by greater than the median absolute deviation, or a predetermined multiple of the median absolute deviation, may be deemed to represent anomalous behavior and trigger transmission of an alert 330 (Step 460) or the like. As another example, variables may be deemed to indicate anomalous behavior, and trigger an alert, when one or more of their values exhibits a sudden change greater than some predetermined amount, or exceeds/falls below a predetermined threshold. Embodiments of the disclosure contemplate any method or approach for determining anomalous behavior from values of determined data flow variables.

If no anomalous behavior is detected, or after an alert is transmitted, the process returns to Step 400 to repeat Steps 400-450, so as to update data flow variables and continue monitoring of applications and edge devices. In some embodiments, the process of FIG. 4 may be repeated continuously, from time to time at any intervals of time, or the like, to continuously monitor the performance of SD-WAN applications with respect to their edge devices.

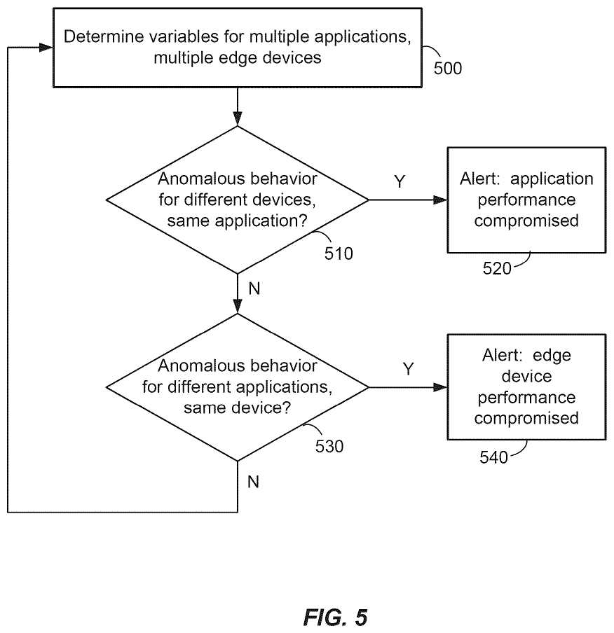

In some SD-WAN applications, it is often desirable to quickly identify problematic application programs or edge devices, in order to restore them to proper operation and avoid compromising user experiences. One of ordinary skill in the art will observe that the above described data flow variables may be used to rapidly identify application programs or edge devices that are exhibiting anomalous behavior. FIG. 5 is a flow chart depicting a method for determining anomalous behavior of SD-WAN applications with respect to edge devices, for use with embodiments of the disclosure described herein. Initially, analytics engine 375 determines data flow variables for multiple applications accessed via multiple edge devices, as above (Step 500). In particular, system 300 may read IP traffic from one or more edge devices each permitting access to multiple application programs, extract flow records such as IPFIX data therefrom, and determine from the IPFIX data and other metrics a data flow variable specific to each application program's traffic on a specific edge device. Thus, in some embodiments of the disclosure, the result of Step 500 is a data flow variable for each application's data flow through a specific edge device.

Analytics engine 375 then analyzes each data flow variable to detect anomalous behavior of each application or edge device. Analytics engine 375 may analyze these data flow variables in any manner. In some embodiments, analytics engine 375 may analyze the data flow variables for the same application across multiple edge devices (Step 510). That is, as one application may be accessed by different users through different edge devices, the analytics engine 375 may analyze the data flow variables corresponding to each different edge device's traffic for the same application. Accordingly, if anomalous behavior occurs for the same application on each different edge device, i.e., if the data flow variables for the same application display anomalous behavior across each edge device, analytics engine 375 may transmit an alert indicating that the performance of that application has been compromised (Step 520). In some embodiments, analytics engine 375 may also, or alternatively, compile and transmit a list 350 of entities impacted by the detected anomalous behavior. Subsequent remedial actions may then focus on that particular application, rather than first investigating particular edge devices or the like.

If no particular application displays anomalous behavior across multiple edge devices, analytics engine 375 may analyze the data flow variables corresponding to each different application's traffic on the same edge device (Step 530). If anomalous behavior occurs across applications on the same edge device, i.e., if the data flow variables for the same edge device display anomalous behavior across the traffic handled by that edge device, analytics engine 375 may transmit an alert indicating that the performance of that edge device has been compromised (Step 540). In some embodiments, analytics engine 375 may also, or alternatively, compile and transmit a list 350 of entities impacted by the detected anomalous behavior. Subsequent remedial actions may then focus on that particular edge device, rather than first investigating particular applications or the like.

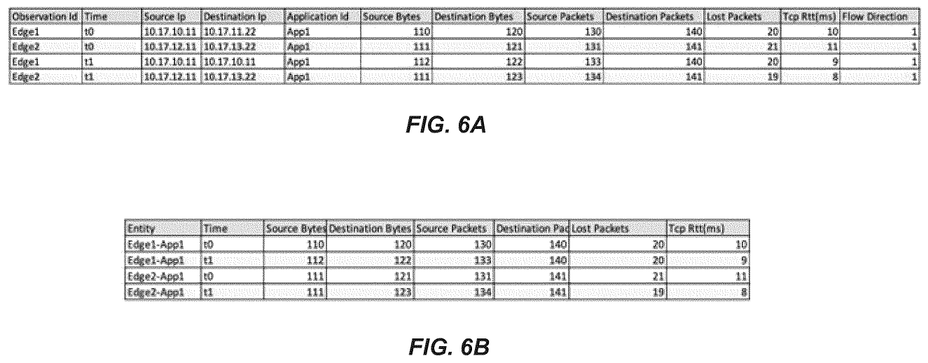

FIGS. 6A-6B illustrate exemplary flow records used in generating variables for monitoring performance of SD-WAN applications with respect to edge devices, for use with embodiments of the disclosure described herein. In some embodiments, FIG. 6A illustrates exemplary IP traffic flow records collected by collector 310, and includes both data flow records such as IPFIX records, as well as metrics determined by metrics collector 360. Here, collector 310 reads packets of IP traffic from two different edge devices, Edge1 and Edge2. Collector 310 may compile any quantities capable of determination from packet data, but in this specific example, collector 310 reads quantities such as the application ID (i.e., the application for which the packets are intended, or from), the source address of the application (for packets from the application), and destination address (for packets sent to the application). In this example, metrics collector 360 also determines metrics including the number of source and destination bytes (e.g., the number of data payload bytes sent to/from the application), number of source and destination packets, number of lost packets, RTT in ms, and flow direction. Also listed is the time period over which the flow data and metrics are determined.

FIG. 6B illustrates the records and metrics of FIG. 6A which are extracted and arranged by collector 310 and platform 320 respectively, to form the above described data flow variables of embodiments of the disclosure. More specifically, the flow records of FIG. 6A that are specific to one edge device and one application are extracted and collected in temporal order, to form an entity describing desired records and metrics of FIG. 6A for one particular edge device and one application. For example, the flow records of edge device Edge1 and application App1 are collected and listed in temporal order, so that the performance of App1 as accessed from Edge1 may be readily determined from a single entity. Here, for instance, entity or variable Edge1-App1 may list lost packets and RTT to impart a temporal picture of data flow to/from application App1 as accessed via edge device Edge1. Similarly, entity or variable Edge2-App2 may describe the same temporal picture for application App2 as accessed via edge device Edge2.

As above, variables such as Edge1-App1 and Edge2-App2 may be used to quickly identify anomalous or problematic behavior of an application and/or edge device. In some embodiments, anomalous or problematic behavior may be determined from quantities such as packet drop and RTT. In some embodiments, anomalous behavior may be determined according to deviations in historical median values of these quantities. For instance, various sensitivity levels may be established, so that the system of embodiments of the disclosure may have greater or lesser sensitivity to changes in variable values before anomalous behavior is found and, e.g., an alert is issued. Sensitivity levels may be implemented in any manner. As one example, packet drop sensitivity may be based on percentage deviation in value from a historical median, while RTT sensitivity may be based on a number of standard deviations from a historical mean RTT value.

In one embodiment of the disclosure, packet drop sensitivity levels may be implemented as a high sensitivity having >1% increase in packet drop from a historic average or median value, with a medium sensitivity having >3% increase in packet drop and a low sensitivity requiring >5% increase in packet drop. Thus, for example, when systems of the disclosure are set to low sensitivity, a 5% increase in packet drop values of a variable such as Edge1-App1 would be required to trigger an alert, while a setting of high sensitivity would require only a 1% increase in packet drop to trigger an alert. It is noted that any number and type of sensitivity levels may be employed, each using any numerical value as its threshold percentage.

Similarly, RTT sensitivity levels may be implemented as a high sensitivity requiring >2 standard deviation increase in RTT from a historic mean or other average value, with a medium sensitivity requiring >2.5 standard deviation increase in RTT and a low sensitivity requiring >3 standard deviation increase to trigger an alert. It is noted that any number and type of sensitivity levels may be employed, each using any numerical value as its threshold number of standard deviations.

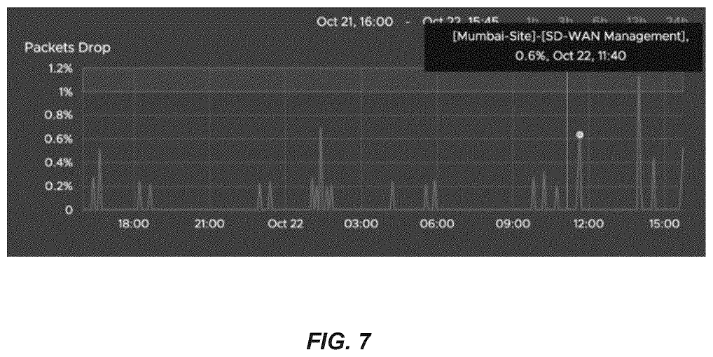

FIG. 7 is a graph of an exemplary variable monitoring performance of an SD-WAN management application with respect to an edge device, illustrating exemplary aspects of embodiments of the disclosure described herein. As above, system 300 may transmit one or more graphs 340 of determined data flow variables when anomalous behavior is detected. FIG. 7 is an illustrative example of one such graph. Shown here is a graph of packet drop data for an SD-WAN management application and the edge device through which it is accessed (in this case, an edge device located at a Mumbai site). Sensitivity in this case is set to high, so that a >1% increase in packet drop may trigger, e.g., an alert or the transmission of the graph of FIG. 7. In this case, a spike in packet drop value shortly before the 15:00 mark exceeds 1%, which may trigger the transmission of this graph to, e.g., users or administrators to troubleshoot a potential problem with either the Mumbai site edge device, or the cloud-based email application. One of ordinary skill in the art will observe that the monitoring and/or analysis methods applied to the graph of FIG. 7 may be applied to any graph generated by any of the above methods, for any application accessed through an SD-WAN edge device. For example, similar graphs generated for other applications such as cloud-based email applications may be analyzed in similar manner, to monitor their performance via any of the methods described herein.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A computer implemented method for monitoring performance of an application with respect to an SD-WAN edge device, the computer implemented method comprising:
receiving data flow records for a plurality of SD-WAN edge devices, wherein the SD-WAN edge devices are configured to permit access to a plurality of application programs, the data flow records comprising data flow information for each application program accessed from each SD-WAN edge device;
for each application program accessed from each SD-WAN edge device, extracting the respective data flow information to form a data flow variable describing data flow of a particular application program accessed from a particular SD-WAN edge device;
determining, from one or more of the data flow variables, whether anomalous behavior of a particular application program accessed from a particular SD-WAN edge device has occurred; and
transmitting an alert to a user if the anomalous behavior has occurred.

2. The computer implemented method of claim 1, further comprising:
determining, from the one or more of the data flow variables, whether a performance reduction of one of the SD-WAN edge devices or of one of the application programs has occurred.

3. The computer implemented method of claim 2, wherein the determining whether a performance reduction of one of the SD-WAN edge devices or of one of the application programs has occurred further comprises:
determining, from the one or more of the data flow variables, whether the anomalous behavior of a first application program accessed from a first SD-WAN edge device has occurred;
determining, from the one or more of the data flow variables, whether the anomalous behavior of the first application program accessed from a second SD-WAN edge device has occurred; and
determining that a performance reduction of the second SD-WAN edge device has occurred when the anomalous behavior of the first application program accessed from the first SD-WAN edge device has not occurred, but the anomalous behavior of the first application program accessed from the second SD-WAN edge device has occurred.

4. The computer implemented method of claim 1, wherein each data flow variable comprises data flow information including one or more of:
an amount of lost packets associated with the respective SD-WAN edge device and application program;
a round trip time associated with the respective SD-WAN edge device and application program;
an amount of retransmitted packets associated with the respective SD-WAN edge device and application program; or
an amount of packet traffic associated with the respective SD-WAN edge device and application program.

5. The computer implemented method of claim 4, wherein the determining whether anomalous behavior of a particular application program accessed from a particular SD-WAN edge device has occurred further comprises:
determining that the anomalous behavior has occurred when the amount of lost packets exceeds a predetermined threshold value.

6. The computer implemented method of claim 4, wherein the determining whether anomalous behavior of a particular application program accessed from a particular SD-WAN edge device has occurred further comprises:
determining that the anomalous behavior has occurred when the round trip time exceeds a predetermined threshold value.

7. The computer implemented method of claim 4, wherein the determining whether anomalous behavior of a particular application program accessed from a particular SD-WAN edge device has occurred further comprises:
determining that the anomalous behavior has occurred according to a median absolute deviation of the corresponding data flow metric.

8. The computer implemented method of claim 1, wherein the data flow records comprise Internet Protocol Flow Information Export (IPFIX) records.

9. The computer implemented method of claim 1, further comprising repeating the receiving, the extracting, and the determining, in order and from time to time, so as to repeatedly perform a determination whether the anomalous behavior has occurred.

10. The computer implemented method of claim 1, wherein the transmitting further comprises transmitting values of the one or more of the data flow variables for display.

11. A non-transitory computer-readable storage medium storing instructions configured to be executed by one or more processors of a computing device, to cause the computing device to carry out steps that include:
receiving data flow records for a plurality of SD-WAN edge devices each permitting access to a plurality of application programs, the data flow records comprising data flow information for each application program accessed from each SD-WAN edge device;
for each application program accessed from each SD-WAN edge device, extracting the respective data flow information so as to form a data flow variable describing data flow of a particular application program accessed from a particular SD-WAN edge device;
determining, from one or more of the data flow variables, whether anomalous behavior of a particular application program accessed from a particular SD-WAN edge device has occurred; and
transmitting an alert to a user if the anomalous behavior has occurred.

12. The non-transitory computer-readable storage medium of claim 11, wherein the instructions, when executed by the one or more processors of the computing device, further cause the computing device to carry out steps that include determining, from the one or more of the data flow variables, whether a performance reduction of one of the SD-WAN edge devices or of one of the application programs has occurred.

13. The non-transitory computer-readable storage medium of claim 12, wherein the determining whether a performance reduction of one of the SD-WAN edge devices or of one of the application programs has occurred further comprises:
determining, from the one or more of the data flow variables, whether the anomalous behavior of a first application program accessed from a first SD-WAN edge device has occurred;
determining, from the one or more of the data flow variables, whether the anomalous behavior of the first application program accessed from a second SD-WAN edge device has occurred; and
determining that a performance reduction of the second SD-WAN edge device has occurred when the anomalous behavior of the first application program accessed from the first SD-WAN edge device has not occurred, but the anomalous behavior of the first application program accessed from the second SD-WAN edge device has occurred.

14. The non-transitory computer-readable storage medium of claim 11, wherein each data flow variable comprises data flow information including one or more of:
an amount of lost packets associated with the respective SD-WAN edge device and application program;
a round trip time associated with the respective SD-WAN edge device and application program;
an amount of retransmitted packets associated with the respective SD-WAN edge device and application program; or
an amount of packet traffic associated with the respective SD-WAN edge device and application program.

15. The non-transitory computer-readable storage medium of claim 14, wherein the determining whether anomalous behavior of a particular application program accessed from a particular SD-WAN edge device has occurred further comprises determining that the anomalous behavior has occurred when the amount of lost packets exceeds a predetermined threshold value.

16. The non-transitory computer-readable storage medium of claim 14, wherein the determining whether anomalous behavior of a particular application program accessed from a particular SD-WAN edge device has occurred further comprises determining that the anomalous behavior has occurred when the round trip time exceeds a predetermined threshold value.

17. The non-transitory computer-readable storage medium of claim 14, wherein the determining whether anomalous behavior of a particular application program accessed from a particular SD-WAN edge device has occurred further comprises determining that the anomalous behavior has occurred according to a median absolute deviation of the corresponding data flow metric.

18. The non-transitory computer-readable storage medium of claim 11, wherein the data flow records comprise Internet Protocol Flow Information Export (IPFIX) records.

19. The non-transitory computer-readable storage medium of claim 11, wherein the instructions, when executed by the one or more processors of the computing device, further cause the computing device to carry out steps that include repeating the receiving, the extracting, and the determining, in order and from time to time, so as to repeatedly perform a determination whether the anomalous behavior has occurred.

20. A computer system, comprising:
one or more processors; and
memory storing one or more programs configured to be executed by the one or more processors, the one or more programs including instructions for:
receiving data flow records for a plurality of SD-WAN edge devices each permitting access to a plurality of application programs, the data flow records comprising data flow information for each application program accessed from each SD-WAN edge device;
for each application program accessed from each SD-WAN edge device, extracting the respective data flow information so as to form a data flow variable describing data flow of a particular application program accessed from a particular wide area network edge device;
determining, from one or more of the data flow variables, whether anomalous behavior of a particular application program accessed from a particular wide area network edge device has occurred; and
transmitting an alert to a user if the anomalous behavior has occurred.
